(19) United States
(12) Patent Application Publication
(10) Pub. No.: US 2015/0103932 A1
(43) Pub. Date: Apr. 16, 2015

(54) CHANNEL ESTIMATION METHOD AND RECEIVER

(71) Applicants: NEC Corporation, Tokyo (JP); NTT DOCOMO, Inc., Tokyo (JP)

(72) Inventors: Toshimichi Yokote, Tokyo (JP); Noriyuki Shimanuki, Tokyo (JP)

(21) Appl. No.: 14/382,447

(22) PCT Filed: Feb. 12, 2013
(86) PCT No.: PCT/JP2013/053782

§ 371 Date: Sep. 2, 2014

(30) Foreign Application Priority Data
Mar. 2, 2012 (JP) 2012-046395

(51) Int. Cl. H04L 25/02; H04L 27/26

(52) U.S. Cl. CPC H04L 25/0202; H04L 27/2601
USPC 375/260

(57) ABSTRACT

To improve the accuracy of a channel estimated value when beam-forming is employed, provided is a channel estimation method including: determining a channel estimated value of a cell-specific reference signal from a cell-specific reference signal; determining a channel estimated value of a UE-specific reference signal from a UE-specific reference signal; calculating a cell-specific channel estimated value by using the channel estimated value of the cell-specific reference signal; estimating a beam-forming vector by using the channel estimated value of the cell-specific reference signal and the channel estimated value of the UE-specific reference signal; and calculating a UE-specific channel estimated value by multiplying the cell-specific channel estimated value by the beam-forming vector.

### TECHNICAL FIELD

This invention relates to a method of estimating a channel when beam-forming is employed from a received signal on a receiver.

### BACKGROUND ART

In recent years, communication technologies have been remarkably developed, and a system for communicating large-capacity data at high speed is being realized. The same applies to not only a case of wired communications but also a case of wireless communications. That is, researches and developments on a next-generation communication system, which allows large-capacity data to be communicated at high speed even wirelessly and multimedia data such as moving images and audio to be used even on mobile terminals, have been performed actively in accordance with widespread use of mobile terminals such as cellular phones.

As the next-generation communication system, attention is being focused on a communication system using such orthogonal frequency division multiplex (OFDM) as represented by Long Term Evolution (LTE) being discussed by 3rd Generation Partnership Project (3GPP). The OFDM is a system for performing transmission by dividing a bandwidth to be used into a plurality of subcarriers and assigning each data symbol to each of the subcarriers, and the subcarriers are arranged so as to be orthogonal to each other on a frequency axis, thereby being superior in frequency utilization efficiency. Further, in the OFDM, each subcarrier becomes a narrow bandwidth, which can suppress an influence of multipath interference, and can realize high-speed and large-capacity communications. In addition, the LTE uses a beam-forming technology for improving a reception characteristic of a user equipment (UE) as a communication target while reducing interference against other than the UE as the communication target by forming a beam for the UE as a communication target (see, for example, Patent Document 1).

On the other hand, in the wireless communications, a received signal exhibits a signal distortion ascribable to multipath phasing or the like in a wireless communication path (channel). Therefore, it is necessary to determine an estimated value (channel estimated value) of a channel characteristic of each subcarrier by using known reference signals transmitted by being multiplexed with a data symbol, and to compensate the signal distortion on a receiver. When the channel estimated value has low accuracy, the signal distortion received in the channel is not appropriately corrected, which deteriorates accuracy of demodulation of the received signal. Therefore, up to now, various systems for improving the accuracy of the channel estimated value are proposed.

For example, in JP-A-2011-166204 (Patent Document 2), there is disclosed a wireless communication system in which reference signals orthogonal to each other are assigned to each wireless base station device while a mobile terminal device performs channel estimation based on the received reference signals.

Further, in JP-T-2011-508527 (Patent Document 3), there is disclosed a MIMO system in which a transmitting end selects a beam-forming vector by using a beam-forming codebook while a receiving end estimates a preferred beam-forming vector and a preferred combining vector by using a combining codebook.

In JP-A-2010-041473 (Patent Document 4), there is disclosed a wireless communication system in which electric power for reference signals is increased at a time of communications using beam-forming, to thereby improve accuracy of the channel estimation at the receiving end.

Note that, in the LTE of 3GPP, a cell-specific reference signal is defined as a reference signal for supporting transmission of control information, alarm information, or normal data that is not subjected to beam-forming. In addition, a UE-specific reference signal is defined as a reference signal for supporting the beam-forming.

In a conventional channel estimation method, as described later in detail with reference to FIG. 7, the receiving end (receiver) independently processes the cell-specific reference signal and the UE-specific reference signal sent from the transmitting end (transmitter), respectively, to obtain a cell-specific channel estimated value and a UE-specific channel estimated value.

### PRIOR ART DOCUMENTS

### Patent Documents

Patent Document 1: JP-A-2009-033717
Patent Document 2: JP-A-2011-166204
Patent Document 3: JP-T-2011-508527
Patent Document 4: JP-A-2010-041473

### DISCLOSURE OF THE INVENTION

### Problems to be Solved by the Invention

None of Patent Documents 2 to 4 discloses or suggests that the reference signals include a cell-specific reference signal and a UE-specific reference signal.

Next, a description is made of problems of a conventional channel estimation method.

The cell-specific reference signal is constantly transmitted over an entire system bandwidth, and hence the number of reference signals that can be used for channel estimation is large. Further, the cell-specific reference signal allows interpolation across a resource block or a subframe. Therefore, it is possible to determine a highly accurate cell-specific channel estimated value from the cell-specific reference signal.

However, the UE-specific reference signal is transmitted only by the resource block by which data is transmitted, and therefore has a problem in that the number of reference signals that can be used for the channel estimation is smaller than in the cell-specific reference signal. In addition, a beam-forming vector can differ even between resource blocks adjacent to each other in a frequency direction and a temporal direction, and hence the UE-specific reference signal cannot perform the interpolation across the resource block or the subframe. Therefore, the UE-specific reference signal has a problem of being inferior to the cell-specific reference signal in the accuracy of the channel estimation.

### Means to Solve the Problems

This invention has a feature of improving, when beam-forming is employed, a reception characteristic by using a beam-forming vector estimated at a receiving end and a highly accurate channel estimated value estimated from the cell-specific reference signal instead of a channel estimated value estimated from a UE-specific reference signal.

That is, according to one embodiment of this invention, there is provided a channel estimation method including: transmitting, at a transmitting end, a signal obtained by inserting a cell-specific reference signal for supporting transmission of normal data that is not subjected to beam-forming and a UE-specific reference signal for supporting the beam-forming into transmission data, as a transmission signal; and receiving, at a receiving end, the transmission signal as a received signal and estimating a cell-specific channel estimated value and a UE-specific channel estimated value from the cell-specific reference signal and the UE-specific reference signal extracted from the received signal, the channel estimation method includes a first step of determining, from the cell-specific reference signal, a channel estimated value of the cell-specific reference signal; a second step of determining, from the UE-specific reference signal, a channel estimated value of the UE-specific reference signal; a third step of calculating the cell-specific channel estimated value by using the channel estimated value of the cell-specific reference signal; a fourth step of estimating a beam-forming vector by using the channel estimated value of the cell-specific reference signal and the channel estimated value of the UE-specific reference signal; and a fifth step of calculating the UE-specific channel estimated value by multiplying the cell-specific channel estimated value by the beam-forming vector.

According to one embodiment of this invention, there is provided a receiver for receiving a transmission signal obtained by inserting a cell-specific reference signal for supporting transmission of normal data that is not subjected to beam-forming and a UE-specific reference signal for supporting the beam-forming into transmission data, as a received signal, the receiver including: a reference signal extraction unit for extracting the cell-specific reference signal and the UE-specific reference signal from the received signal; and a channel estimation unit for estimating a cell-specific channel estimated value and a UE-specific channel estimated value from the cell-specific reference signal and the UE-specific reference signal, the channel estimation unit including: a cell-specific reference signal pattern-cancel unit for canceling a pseudo-random pattern from the cell-specific reference signal to determine a channel estimated value of the cell-specific reference signal; a UE-specific reference signal pattern-cancel unit for canceling a pseudo-random pattern from the UE-specific reference signal to determine a channel estimated value of the UE-specific reference signal; a cell-specific reference signal channel estimation unit for performing noise control and the interpolation processing by using the channel estimated value of the cell-specific reference signal to calculate the cell-specific channel estimated value; a beam-forming vector estimation unit for estimating a beam-forming vector by using the channel estimated value of the cell-specific reference signal and the channel estimated value of the UE-specific reference signal; and a UE-specific reference signal channel estimation unit for calculating the UE-specific channel estimated value by multiplying the cell-specific channel estimated value by the beam-forming vector.

### Effect of the Invention

According to one embodiment of this invention, it is possible to improve the accuracy of the channel estimated value when the beam-forming is employed.

### BRIEF DESCRIPTION OF THE DRAWINGS

FIG. 1 is a block diagram illustrating a general configuration of a two-transmission-antenna transmitter of LTE compatible with beam-forming;

FIG. 2 is a block diagram illustrating a general configuration of a receiver of the LTE;

FIG. 3 is a block diagram illustrating a configuration of a channel estimation unit according to a first exemplary embodiment of this invention, which is used by the receiver illustrated in FIG. 2;

FIG. 4 is a diagram illustrating a state of mapping of reference signals;

FIG. 5 is a table showing a beam-forming vector used at a transmitting end;

FIG. 6 is a diagram illustrating how the reference signals are divided into a first half slot and a second half slot; and

FIG. 7 is a block diagram illustrating a configuration (related art) of a general channel estimation unit of a receiver of the LTE.

### MODE FOR EMBODYING THE INVENTION

Now, a description is made of an exemplary embodiment of this invention by using LTE of 3GPP.

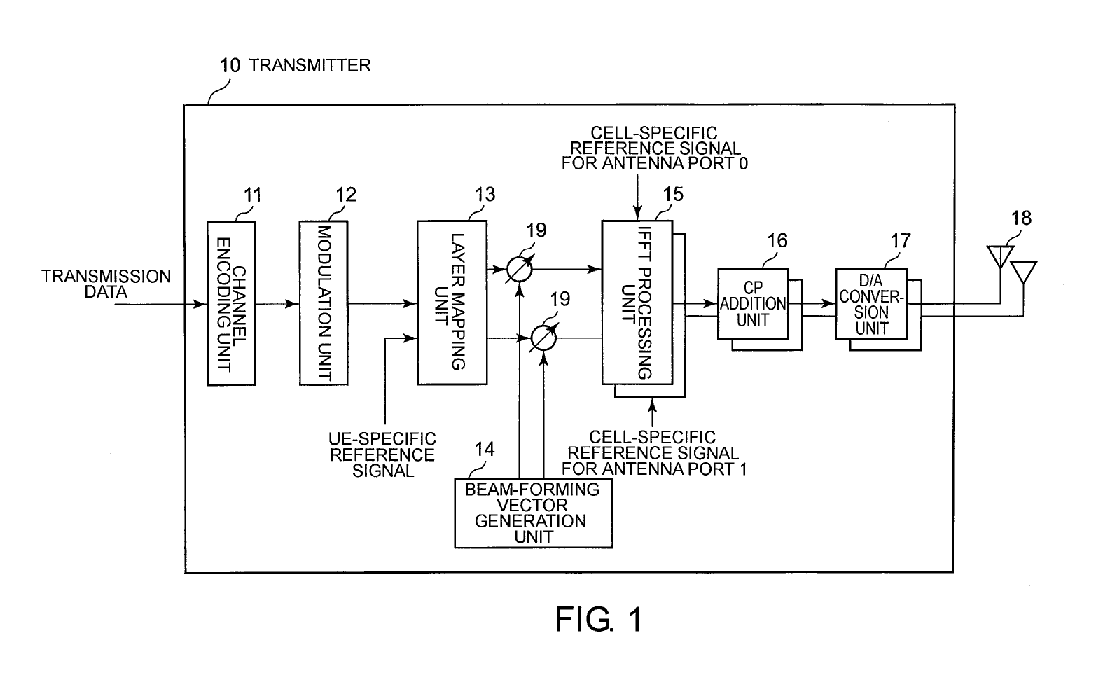

FIG. 1 is a block diagram illustrating a general configuration of a two-transmission-antenna transmitter 10 of LTE compatible with beam-forming.

The transmitter 10 comprises a channel encoding unit 11, a modulation unit 12, a layer mapping unit 13, a beam-forming vector generation unit 14, inverse fast Fourier transform (IFFT) processing units 15, cyclic prefix (CP) addition units 16, digital/analog (D/A) conversion units 17, transmission antennas 18, and multipliers 19.

First referring to FIG. 1, an operation of the transmitter 10 will be described. The operation of the transmitter 10 is a general one.

In the transmitter 10, first, the channel encoding unit 11 performs error detection encoding/error correction encoding for transmission data addressed to each user. Then, the modulation unit 12 maps a signal subjected to the error detection encoding/error correction encoding into an I-component and a Q-component.

Subsequently, the layer mapping unit 13 assigns the signal after modulation to two layers. In a case of the beam-forming, the layer mapping unit 13 inserts a UE-specific reference signal before layer mapping. The layer mapping unit 13 multiplexes data with the two layers.

The beam-forming vector generation unit 14 generates beam-forming vectors based on a received up-link signal or feedback from the UE. The multipliers 19 multiply the generated beam-forming vectors by outputs from the layer mapping unit 13.

In addition, Each IFFT processing unit 15 inserts a cell-specific reference signal into the output signal from each multiplier 19, and then converts the resultant into a signal wave in a time domain. Each CP addition unit 16 adds a CP to a head of an OFDM symbol in order to prevent influence of an inter-symbol interference due to a multipath. Each D/A conversion unit 17 converts the OFDM symbol to which the CP is added from a digital signal into an analog signal. Each transmission antenna 18 transmits the converted analog signal as a transmission signal.

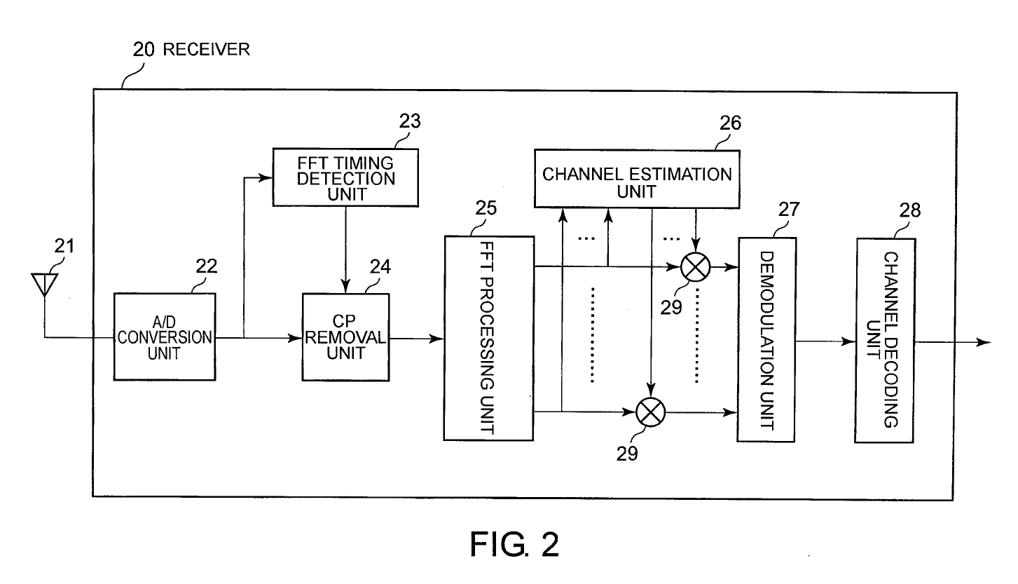

FIG. 2 is a block diagram illustrating a general configuration of a receiver 20 of the LTE.

The receiver 20 comprises a reception antenna 21, an analog/digital (A/D) conversion unit 22, a fast Fourier transform (FFT) timing detection unit 23, a CP removal unit 24, an FFT processing unit 25, a channel estimation unit 26, a demodulation unit 27, a channel decoding unit 28, and multipliers 29.

Next, an operation of the receiver 20 is described with reference to FIG. 2. The operation of the receiver 20 is also a general one except for the channel estimation unit 26.

At the receiver 20, the reception antenna 21 receives the transmission signal transmitted by the transmitter 10 as a received signal. The A/D conversion unit 22 converts the received signal from the analog signal into a digital signal. The converted digital signal is supplied to the FFT timing detection unit 23 and the CP removal unit 24.

The CP removal unit 24 removes the CP added to the head from the OFDM symbol based on FFT timing information detected by the FFT timing detection unit 23. The FFT processing unit 25 converts the OFDM symbol from which the CP has been removed from the signal wave in the time domain into each subcarrier component.

A combination of the A/D conversion unit 22, the FFT timing detection unit 23, the CP removal unit, and the FFT processing unit 25 functions as a reference signal extraction unit for extracting the cell-specific reference signal and the UE-specific reference signal from the received signal.

In addition, the channel estimation unit 26 determines a channel estimated value of each subcarrier by using known reference signals (cell-specific reference signal and UE-specific reference signal) transmitted by being multiplexed with a data symbol. Each multiplier 29 multiplies the received signal of each subcarrier by a complex conjugate of the channel estimated value. This allows compensation (channel equalization) of a signal distortion caused in a channel.

The demodulation unit 27 converts the received signal of each subcarrier, in which influence of the channel has been compensated, from the I-component and the Q-component into likelihood information. The channel decoding unit 28 performs error correction decoding/error detection for the converted likelihood information. The received data is thus obtained.

For an easy understanding of this invention, referring to FIG. 7, a general channel estimation operation (related art) of a receiver of the LTE will be described. The receiver has the same configuration as that of FIG. 2 except for the channel estimation.

A general channel estimation unit 26′ illustrated in FIG. 7 comprises a cell-specific reference signal pattern-cancel unit 41, a UE-specific reference signal pattern-cancel unit 42 a cell-specific reference signal channel estimation unit 43, and a UE-specific reference signal channel estimation unit 44.

The cell-specific reference signal and the UE-specific reference signal included in the output from the FFT processing unit 25 are input to the general channel estimation unit 26′ illustrated in FIG. 7.

The cell-specific reference signal pattern-cancel unit 41 cancels a pseudo-random pattern applied to the cell-specific reference signal to determine a channel estimated value of the cell-specific reference signal. The UE-specific reference signal pattern-cancel unit 42 cancels a pseudo-random pattern applied to the UE-specific reference signal to determine a channel estimated value of the UE-specific reference signal.

The channel estimated value of the cell-specific reference signal and the channel estimated value of the UE-specific reference signal are supplied to the cell-specific reference signal channel estimation unit 43 and the UE-specific reference signal channel estimation unit 44, respectively.

The cell-specific reference signal channel estimation unit 43 performs noise suppression and interpolation processing by using the channel estimated value of the cell-specific reference signal, to thereby calculate a cell-specific channel estimated value to be used for demodulation of control information, alarm information, or data that is not subjected to beam-forming.

On the other hand, the UE-specific reference signal channel estimation unit 44 performs the noise suppression and the interpolation processing by using the channel estimated value of the UE-specific reference signal, to thereby calculate a UE-specific channel estimated value to be used for demodulation of data subjected to beam-forming.

The cell-specific reference signal is constantly transmitted over an entire system bandwidth, and hence the number of reference signals that can be used for the channel estimation is large. Further, the cell-specific reference signal allows interpolation across a resource block or a subframe, and hence it is possible to determine a highly accurate channel estimated value therefrom.

However, the UE-specific reference signal is transmitted only by the resource block by which data is transmitted. Therefore, the UE-specific reference signal has a problem in that the number of reference signals that can be used for the channel estimation is smaller than in the cell-specific reference signal. In addition, the beam-forming vectors can differ even between resource blocks adjacent to each other in a frequency direction and a temporal direction. As a result, the UE-specific reference signal does not allow the interpolation across the resource block or the subframe. Therefore, the UE-specific reference signal has a problem of being inferior to the cell-specific reference signal in the accuracy of the channel estimation.

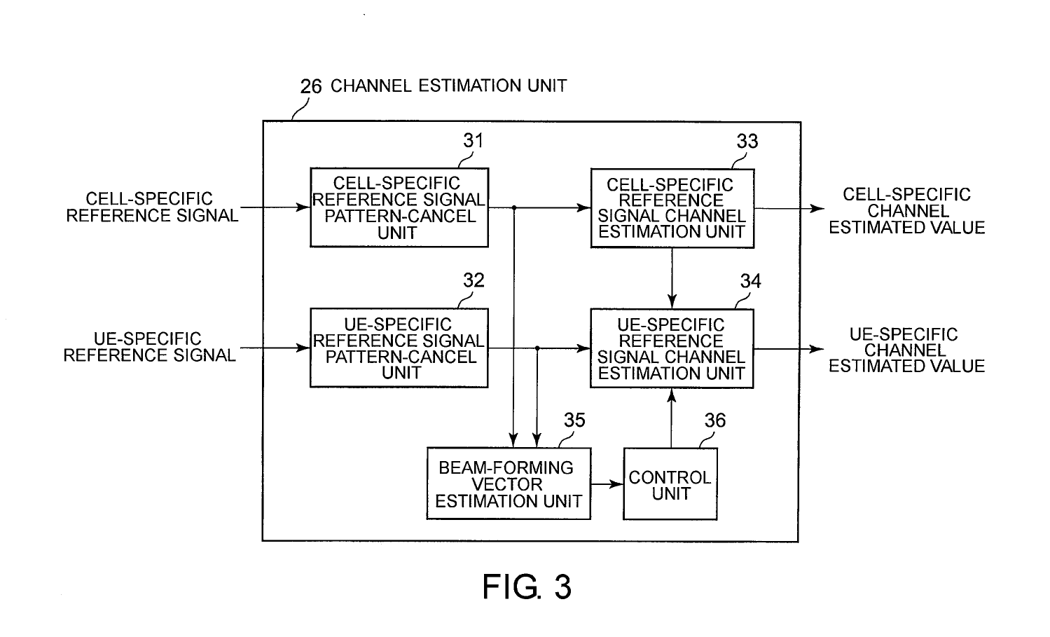

FIG. 3 is a block diagram illustrating a configuration of the channel estimation unit 26 according to the first exemplary embodiment of this invention.

The channel estimation unit 26 according to the exemplary embodiment of this invention comprises a cell-specific reference signal pattern-cancel unit 31, a UE-specific reference signal pattern-cancel unit 32, a cell-specific reference signal channel estimation unit 33, a UE-specific reference signal channel estimation unit 34, a beam-forming vector estimation unit 35, and a control unit 36.

Referring now to FIG. 3, an operation for the channel estimation according to the exemplary embodiment of this invention will be described.

The cell-specific reference signal and the UE-specific reference signal included in the output from the FFT processing unit 25 are supplied to the channel estimation unit 26.

The cell-specific reference signal pattern-cancel unit 31 cancels the pseudo-random pattern applied to the cell-specific reference signal to determine the channel estimated value of the cell-specific reference signal. The UE-specific reference signal pattern-cancel unit 32 cancels the pseudo-random pattern applied to the UE-specific reference signal to determine the channel estimated value of the UE-specific reference signal.

The channel estimated value of the cell-specific reference signal and the channel estimated value of the UE-specific reference signal are supplied to the cell-specific reference signal channel estimation unit 33 and the UE-specific reference signal channel estimation unit 34, respectively. Further, the channel estimated value of the cell-specific reference signal and the channel estimated value of the UE-specific reference signal are also supplied to the beam-forming vector estimation unit 35.

The cell-specific reference signal channel estimation unit 33 performs the noise suppression and the interpolation processing by using the channel estimated value of the cell-specific reference signal, to thereby calculate the cell-specific channel estimated value to be used for the demodulation of the control information, the alarm information, or the data that is not subjected to the beam-forming.

On the other hand, the beam-forming vector estimation unit 35 uses the channel estimated value of the cell-specific reference signal and the channel estimated value of the UE-specific reference signal to estimate the beam-forming vector used for the transmission.

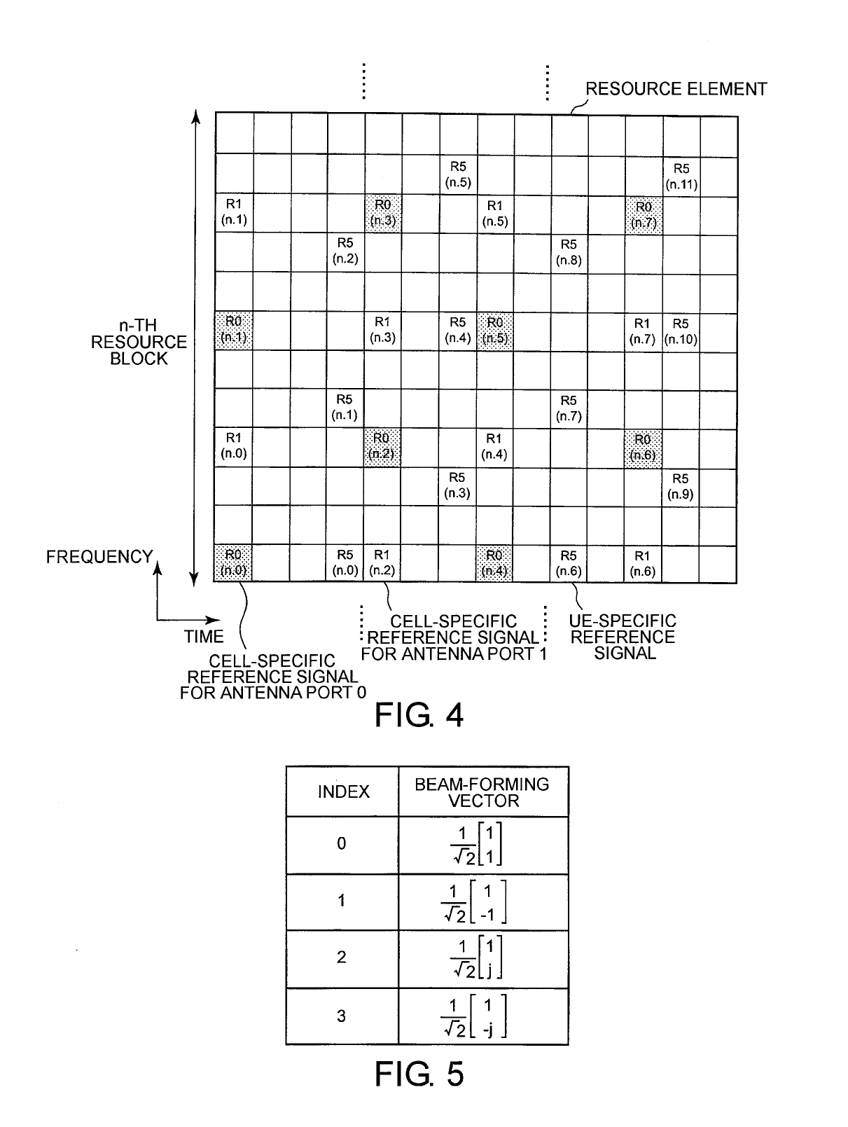

As illustrated in FIG. 4, a reference signal for an antenna port 0, a reference signal for an antenna port 1, and a UE-specific reference signal are mapped to resource elements that are different from one another.

It is assumed here that a k-th channel estimated value of the cell-specific reference signal for the antenna port 0 included in an n-th resource block is
R0(n, k), k=0, 1, 2, . . . , K−1;
   a k-th channel estimated value of the cell-specific reference signal for the antenna port 1 is
R1(n, k), k=0, 1, 2, . . . , K−1; and
   an estimated value of an l-th channel of the UE-specific reference signal is
R5(n, l), l=0, 1, 2, . . . , L−1.
   The beam-forming vector w(n) used for the n-th resource block can be expressed by the following Expression 1 by using R0(n, k), R1(n, k), and R5(n, 1).

$$\tilde{R} 5 ( n ) = [ \begin{matrix}\tilde{R} 0 ( n ) & \tilde{R} 1 ( n )\end{matrix} ] w ( n ) \\ \tilde{R} 0 = {\sum }_{k = 0}^{K - 1} R 0 ( n , k ) \\ \tilde{R} 1 = {\sum }_{k = 0}^{K - 1} R 1 ( n , k ) \\ \tilde{R} 5 = {\sum }_{l = 0}^{L - 1} R 5 ( n , l ) \qquad Expression 1$$

It is assumed that the beam-forming vector used at a transmitting end is given as shown in FIG. 5. In this case, the beam-forming vector used at the transmitting end can be estimated by selecting a vector for which an arithmetic operation result of

[\tilde{R}0(n)\tilde{R}1(n)]w(n) Expression 2

is closest to

R5(n) Expression 3.

The beam-forming vector estimated by the beam-forming vector estimation unit 35 is supplied to the control unit 36. The control unit 36 uses the result to control the operation of the channel estimation unit 34 for the UE-specific reference signal.

Specifically, the UE-specific reference signal channel estimation unit 34 calculates the UE-specific channel estimation value by multiplying the cell-specific channel estimated value estimated by the cell-specific reference signal channel estimation unit 33 by the beam-forming vector estimated by the beam-forming vector estimation unit 35.

Next, effects of the first exemplary embodiment of this invention will be described.

The UE-specific reference signal is transmitted only by the resource block by which data is transmitted, and is therefore smaller in the number of reference signals that can be used for the channel estimation than the cell-specific reference signal. In addition, the beam-forming vectors can differ even between the resource blocks adjacent to each other in the frequency direction and the temporal direction, and hence the UE-specific reference signal does not allow the interpolation across the resource block or the subframe.

In contrast, the cell-specific reference signal is constantly transmitted over the entire system bandwidth, and hence the number of reference signals that can be used for the channel estimation is large. Further, the cell-specific reference signal allows the interpolation across the resource block or the subframe, and hence it is possible to determine the highly accurate channel estimated value therefrom. Therefore, it is possible to improve a reception characteristic by using the beam-forming vector estimated at the receiving end and the highly accurate channel estimated value estimated from the cell-specific reference signal instead of the channel estimated value estimated from the UE-specific reference signal.

In addition, the channel estimated value of the cell-specific reference signal is constantly calculated in order to receive the control information or the alarm information. Therefore, channel estimation processing for the UE-specific reference signal can be simplified by reusing the channel estimated value of the cell-specific reference signal even when the beam-forming is employed.

While the invention has been particularly shown and described with reference to exemplary embodiment thereof, the invention is not limited to the above-mentioned exemplary embodiment. It will be understood by those of ordinary skill in the art that various changes in form and details may be made to therein without departing from the spirit and scope of the invention as defined by the claims.

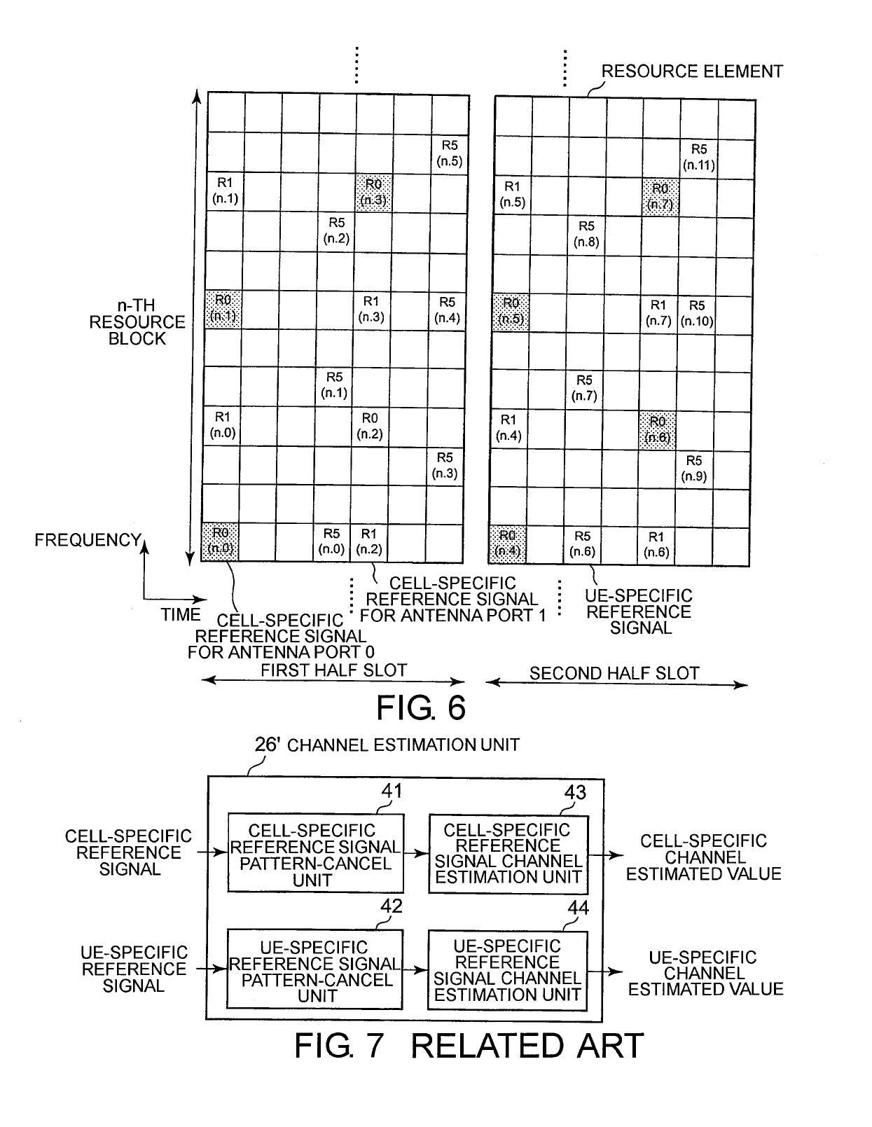

For example, in the above-mentioned first exemplary embodiment of this invention, the case where the beam-forming vector is selected from the predetermined patterns as shown in FIG. 5 is taken as an example, but a case where the beam-forming vector can be freely determined at the transmitting end is also conceivable. In such a case, as illustrated in FIG. 6, the reference signals are divided into a first half slot and a second half slot, and simultaneous equations such as the following Expression 4 are solved, to thereby be able to estimate the beam-forming vector w(n).

$$\{ \begin{matrix}\tilde{R} 5 , 0 ( n ) = a \tilde{R} 0 , 0 ( n ) + b \tilde{R} 1 , 0 ( n ) \\ \tilde{R} 5 , 1 ( n ) = a \tilde{R} 0 , 1 ( n ) + b \tilde{R } 1 , 1 ( n )\end{matrix} \\ \tilde{R} 0 , 0 ( n ) = {\sum }_{k = 0}^{K / 2 - 1} R 0 ( n , k ) \tilde{R} 0 , 1 ( n ) = {\sum }_{k = K / 2}^{K - 1} R 0 ( n , k ) \\ \tilde{R} 1 , 0 ( n ) = {\sum }_{k = 0}^{K / 2 - 1} R 1 ( n , k ) \tilde{R} 1 , 1 ( n ) = {\sum }_{k = K / 2}^{K - 1} R 1 ( n , k ) \\ \tilde{R} 5 , 0 ( n ) = {\sum }_{l = 0}^{L / 2 - 1} R 5 ( n , l ) \tilde{R} 5 , 1 ( n ) = {\sum }_{l = L / 2}^{L - 1} R 5 ( n , l ) \\ w ( n ) = [ \begin{matrix}a \\ b\end{matrix} ] \qquad Expression 4$$

Note that, the reference signals are not necessarily divided into the first half slot and the second half slot. The reference signals may be divided into two groups of a low-frequency group and a high-frequency group within the resource block, or may further be divided into two or more groups or grouped in terms of both the slot and the frequency.

Further, in the above-mentioned exemplary embodiment, the case where the cell-specific reference signal and the UE-specific reference signal are being transmitted from the same physical antenna is taken as an example, but a case where the respective reference signals are being transmitted from different physical antennas is also conceivable. In such a case, the respective reference signals pass through different channels, and hence the UE-specific channel estimation value cannot be calculated by using the cell-specific reference signal. Therefore, the channel estimation needs to be performed by using only the UE-specific reference signal. It may be determined whether or not the respective reference signals are being transmitted from the different physical antenna by, for example, calculating an error between the predetermined beam-forming vector as shown in FIG. 5 and the estimated beam-forming vector. When the error is large, it can be determined that the respective reference signals are being transmitted from the different physical antennas. Alternatively, an error between a value obtained by multiplying the channel estimated value of the cell-specific reference signal by the estimated beam-forming vector and the channel estimated value of the UE-specific reference signal is calculated, and when the error is large, it is possible to determine that the respective reference signals are being transmitted from the different physical antennas.

Note that, the above-mentioned exemplary embodiment is described by using a reference signal layout in LTE Transmission mode 7, but this invention is not necessarily limited thereto. This invention can be applied to Transmission mode 8 or an upper transmission mode.

In addition, the description is made above by taking the example of the LTE being discussed by 3GPP, but this invention is not necessarily limited thereto. This invention can be applied to another wireless communication system using beam-forming in the same manner.

### INDUSTRIAL APPLICABILITY

This invention can be used for a receiver of a communication device such as a cellular phone, a data communication card, a personal handyphone system (PHS), a personal data assistance or personal digital assistants (PDAs), a smartphone, or a wireless base station.

### REFERENCE SIGNS LIST

10 transmitter
11 channel encoding unit
12 modulation unit
13 layer mapping unit
14 beam-forming vector generation unit
15 IFFT processing unit
16 CP addition unit
17 D/A conversion unit
18 transmission antenna
19 multiplier
20 receiver
21 reception antenna
22 A/D conversion unit
23 FFT timing detection unit
24 CP removal unit
25 FFT processing unit
26 channel estimation unit
27 demodulation unit
28 channel decoding unit
29 multiplier
31 cell-specific reference signal pattern-cancel unit
32 UE-specific reference signal pattern-cancel unit
33 cell-specific reference signal channel estimation unit
34 UE-specific reference signal channel estimation unit
35 beam-forming vector estimation unit
36 control unit

This application is based upon and claims the benefit of priority from Japanese Patent Application No. 2012-046395, filed on Mar. 2, 2012, the disclosure of which is incorporated herein in its entirety by reference.

1. A channel estimation method, comprising:
transmitting, at a transmitting end, a signal obtained by inserting a cell-specific reference signal for supporting transmission of normal data that is not subjected to beam-forming and a UE-specific reference signal for supporting the beam-forming into transmission data, as a transmission signal; and
receiving, at a receiving end, the transmission signal as a received signal and estimating a cell-specific channel estimated value and a UE-specific channel estimated value from the cell-specific reference signal and the UE-specific reference signal extracted from the received signal,
wherein the channel estimation method include:
determining, from the cell-specific reference signal, a channel estimated value of the cell-specific reference signal;
determining, from the UE-specific reference signal, a channel estimated value of the UE-specific reference signal;
calculating the cell-specific channel estimated value by using the channel estimated value of the cell-specific reference signal;
estimating a beam-forming vector by using the channel estimated value of the cell-specific reference signal and the channel estimated value of the UE-specific reference signal; and
calculating the UE-specific channel estimated value by multiplying the cell-specific channel estimated value by the beam-forming vector.

2. The channel estimation method according to claim 1, wherein the estimating estimates the beam-forming vector from patterns of predetermined beam-forming vectors.

3. The channel estimation method according to claim 1, wherein the calculating the UE-specific channel estimated value estimates whether or not the cell-specific reference signal and the UE-specific reference signal are transmitted from the same physical antenna, and calculates, when the cell-specific reference signal and the UE-specific reference signal are transmitted from different physical antennas, the UE-specific channel estimated value by using the channel estimated value of the UE-specific reference signal.

4. The channel estimation method according to claim 3, wherein the calculating the UE-specific channel estimated value estimates whether or not the cell-specific reference signal and the UE-specific reference signal are transmitted from the same physical antenna by using the channel estimated value of the cell-specific reference signal and the channel estimated value of the UE-specific reference signal.

5. The channel estimation method according to claim 1, further comprising using OFDM as a wireless communication system.

6. The channel estimation method according to claim 1, further comprising using LTE as a wireless communication system.

7. A receiver for receiving a transmission signal obtained by inserting a cell-specific reference signal for supporting transmission of normal data that is not subjected to beam-forming and a UE-specific reference signal for supporting the beam-forming into transmission data, as a received signal, the receiver comprising:
a reference signal extraction unit extracting the cell-specific reference signal and the UE-specific reference signal from the received signal; and
a channel estimation unit estimating a cell-specific channel estimated value and a UE-specific channel estimated value from the cell-specific reference signal and the UE-specific reference signal,
wherein the channel estimation unit comprises:
a cell-specific reference signal pattern-cancel unit canceling a pseudo-random pattern from the cell-specific reference signal to determine a channel estimated value of the cell-specific reference signal;
a UE-specific reference signal pattern-cancel unit canceling a pseudo-random pattern from the UE-specific reference signal to determine a channel estimation value of the UE-specific reference signal;
a cell-specific reference signal channel estimation unit performing noise control and interpolation processing by using the channel estimated value of the cell-specific reference signal to calculate the cell-specific channel estimation value;
a beam-forming vector estimation unit estimating a beam-forming vector by using the channel estimated value of the cell-specific reference signal and the channel estimated value of the UE-specific reference signal; and
a UE-specific reference signal channel estimation unit calculating the UE-specific channel estimated value by multiplying the cell-specific channel estimated value by the beam-forming vector.

8. The receiver according to claim 7, wherein the beam-forming vector estimation unit estimates the beam-forming vector from patterns of predetermined beam-forming vectors.

9. The receiver according to claim 7, wherein the UE-specific reference signal channel estimation unit estimates whether or not the cell-specific reference signal and the UE-specific reference signal are transmitted from the same physical antenna, and calculates, when the cell-specific reference signal and the UE-specific reference signal are transmitted from different physical antennas, the UE-specific channel estimated value by using the channel estimated value of the UE-specific reference signal.

10. The receiver according to claim 9, wherein the UE-specific reference signal channel estimation unit estimates whether or not the cell-specific reference signal and the UE-specific reference signal are transmitted from the same physical antenna by using the channel estimated value of the cell-specific reference signal and the channel estimated value of the UE-specific reference signal.

11. The receiver according to claim 7, wherein the receiver uses OFDM as a wireless communication system.

12. The receiver according to claim 7, wherein the receiver uses LTE as a wireless communication system.

13. The channel estimation method according to claim 2, wherein the calculating the UE-specific channel estimated value estimates whether or not the cell-specific reference signal and the UE-specific reference signal are transmitted from the same physical antenna, and calculates, when the cell-specific reference signal and the UE-specific reference signal are transmitted from different physical antennas, the UE-specific channel estimated value by using the channel estimated value of the UE-specific reference signal.

14. The channel estimation method according to claim 2, further comprising using OFDM as a wireless communication system.

15. The channel estimation method according to claim 3, further comprising using OFDM as a wireless communication system.

16. The channel estimation method according to claim 4, further comprising using OFDM as a wireless communication system.

17. The channel estimation method according to claim 2, further comprising using LTE as a wireless communication system.

18. The channel estimation method according to claim 3, further comprising using LTE as a wireless communication system.

19. The channel estimation method according to claim 4, further comprising using LTE as a wireless communication system.

20. The channel estimation method according to claim 5, further comprising using LTE as a wireless communication system.
